(19) United States
(12) Patent Application Publication
(10) Pub. No.: US 2010/0312644 A1
(43) Pub. Date: Dec. 9, 2010

(54) GENERATING RECOMMENDATIONS THROUGH USE OF A TRUSTED NETWORK

(75) Inventors: Christian Herwarth Borgs, Boston, MA (US); Danah Michele Body, Boston, MA (US); Jennifer Tour Chayes, Boston, MA (US); Adam Tauman Kalai, Cambridge, MA (US); Moshe Tennenholtz, Haifa (IL)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/477,914

(22) Filed: Jun. 4, 2009

(51) Int. Cl. G06Q 10/00; G06F 15/18; G06Q 30/00; G06N 5/02; G06F 3/048

(52) U.S. Cl. 705/14.55; 706/12; 706/46; 715/764; 705/319; 705/347

(57) ABSTRACT

Described herein are various techniques for automatically generating recommendations for a user based upon a social network of the user. A user can request a recommendation for a particular context, and a social network of the user can be automatically pared to create a subnetwork, wherein individuals in the subnetwork have provided ratings for the particular context and/or contexts that are in some way related to the particular context. The knowledge/ratings of individuals in the subnetwork may then be leveraged to automatically generate the recommendation for the particular context.

### BACKGROUND

Social networks can be thought of as a social structure that includes nodes that represent individuals or organizations that are interconnected by at least one type of interdependency, such as common values, visions, ideas, friendship, etc. Thus, a social network of an individual may include coworkers of the individual, schoolmates of the individual, friends of the individual, family of the individual, and other people that have a trusted relationship with the individual. In other words, people in a social network of the individual are known to such individual, and the individual is in some way comfortable with those people in the social network. Thus, typically, an individual would rather receive recommendations or advice from a person in the social network of the individual rather than, for instance, an unknown person.

Advances in computing and network technologies have caused social networks of individuals to be embodied/represented in a computer-readable format. For example, email applications are today commonplace, and an individual may have numerous email contact saved in an email application. Each of the email contacts can be thought of as an individual in the social network of the owner of an email account. In another example, many web sites are now dedicated to social networking, such that an individual can post pictures, videos, etc. of events pertaining to the life of the individual, and can allow trusted friends to view and comment on such photographs and videos. Furthermore, through use of one of such web sites, an individual can post web logs or status updates such that others in the social network of the individual can quickly discern recent events in the life of the individual. Typically, to become a contact of an individual on one of these social networking sites, two people must reach an agreement indicating that they know one another and that they accept each other as a social contact.

Furthermore, many of these social networking web sites are designed to capture different relationships. For example, a first social networking web site may be configured to embody business relationships between individuals, while a second web site may be less formal and configured to embody a less formal, more friendly, social network. Thus, different social networking sites are configured for different portions of a social network of an individual. In an example, if the individual were attempting to start a career in a certain field, such individual may contact people using a first social networking site for recommendations, while if the individual were searching for a restaurant at which to eat that evening, the individual may contact a second group of people via a second social networking site.

Currently it is difficult to leverage a social network of an individual to obtain specific information about a certain item or topic via the social network. For example, it can be time consuming for an individual to contact multiple people in the social network of the individual to obtain certain information. Furthermore, even if the individual had an automated mechanism for contacting each person in the social network of the individual, many of those individuals would have no helpful information to provide. For example, a contact living in Los Angeles would likely be unable to provide helpful information about which restaurant an individual should eat at on a Saturday in Boston.

### SUMMARY

The following is a brief summary of subject matter that is described in greater detail herein. This summary is not intended to be limiting as to the scope of the claims.

Described herein are various technologies pertaining to leveraging collective information in a social network of a user to automatically provide the user with a recommendation for a given context. As used herein, a context can be a topic, a certain item, a circumstance or set of circumstances, etc. A social network of a user may be embodied in a first data set that can be stored in a data store. For example, the first data set can be represented by a graph which in turn can represent the social network of the user. For instance, the graph may include a plurality of nodes that represent a plurality of individuals in the social network of the user (e.g., each note represents one individual in the social network of the user). The nodes can be connected by edges that represent a trusted relationship between individuals in the social network. Pursuant to an example, the edges can be weighted to indicate a level of trust between individuals, and can be directional in nature (e.g., an edge in one direction can indicate that a first individual is a contact of a second individual, while an edge in an opposite direction between nodes can indicate that the second individual is a contact of the first individual).

Furthermore, individuals in the social network of the user may have provided ratings for particular contexts. For example, individuals in the social network of the user may provide ratings with respect to restaurants, types of restaurants, movies, music, art, doctors, employers, etc. In many cases, these types of ratings may be beneficial to the individual. Not all individuals in the social network of the user, however, may have information that is useful to the user for a particular context. Accordingly, for a certain context, the social network of the user can be pared to generate a subnetwork of the social network, wherein the subnetwork comprises individuals that have useful information to the user for the certain context. Thus, conceptually, one or more edges and/or one or more nodes of the graph that represents the social network of the user can be automatically removed, thereby generating a subnetwork that comprises individuals that have provided ratings with respect to one or more contexts that are useful to the user with respect to a particular context.

The subnetwork and ratings corresponding to individuals in the subnetwork can then be leveraged to cause a recommendation for the particular context to be provided to the user. For instance, one or more recommendation algorithms may be executed over the subnetwork, wherein the recommendation is for the particular context. Pursuant to an example, the user may indicate that she wishes to be provided a recommendation for a pizzeria in Chicago. The social network of the user can be automatically pared to remove individuals that do not have information that is useful to the request of the user, thereby creating a subnetwork that comprises individuals that can provide the user with useful information with respect to the request. This knowledge of individuals that are in some way trusted by the user can be leveraged to automatically provide a recommendation for the context (e.g., provide a recommendation for a pizzeria in Chicago).

Other aspects will be appreciated upon reading and understanding the attached figures and description.

### BRIEF DESCRIPTION OF THE DRAWINGS

FIG. 1 is a functional block diagram of an example system that facilitates generating a recommendation for a particular context based at least in part upon a subnetwork of a social network of a user.

FIG. 2 is a functional block diagram of an example system that facilitates aggregating data from multiple social network sources to embody a social network of a user in a computer readable medium.

FIG. 3 is an example depiction of a graph that represents a social network of a user.

FIG. 4 is an example depiction of a graph that represents relationships between contexts.

FIG. 5 is a functional block diagram of an example system that facilitates generating a subnetwork of a social network of a user for a particular context.

FIG. 6 is a functional block diagram of an example system that facilitates updating a learned subnetwork of a social network of a user and learned context relationships based upon feedback from a user pertaining to a recommendation provided to such user.

FIG. 7 is a flow diagram that illustrates an example methodology for generating a recommendation based at least in part upon a subnetwork of a social network of a user.

FIG. 8 is a flow diagram that illustrates an example methodology for automatically modifying a social network of a user to generate a subnetwork for a particular context.

FIG. 9 is a flow diagram that illustrates an example methodology for executing a recommendation algorithm over a learned subnetwork of a social network of a user for a particular context.

FIG. 10 is an example computing system.

### DETAILED DESCRIPTION

Various technologies pertaining to the automatic generation of recommendations will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

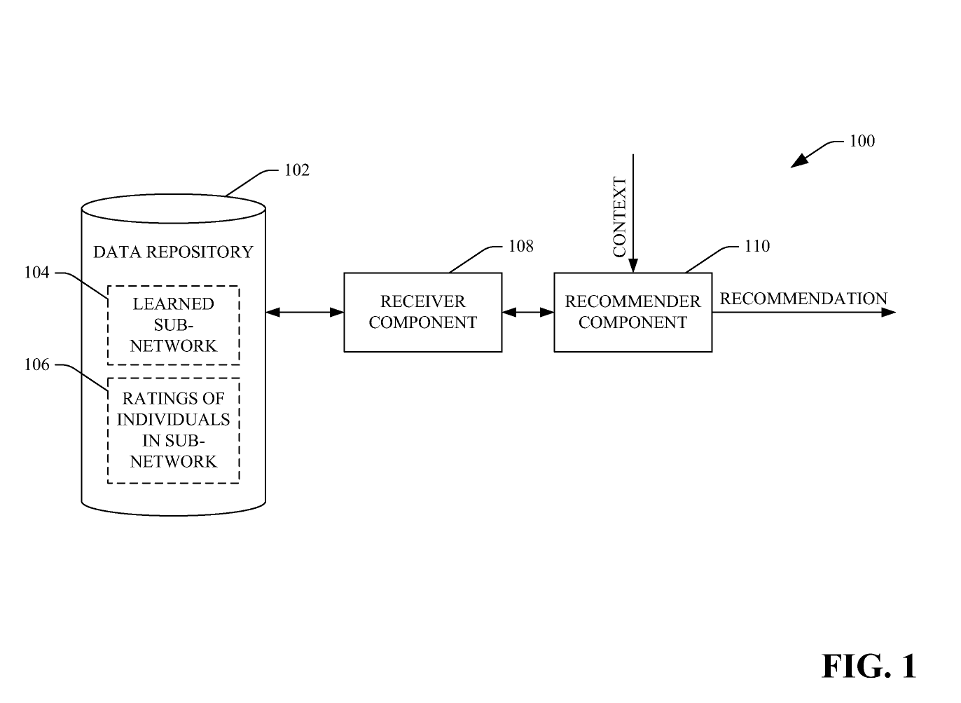

With reference to FIG. 1, an example system 100 that facilitates automatically generating a recommendation for a user for a particular context is illustrated. The system 100 includes a data repository 102 that comprises data representative of a learned subnetwork 104 of a social network of a user and ratings 106 with respect to various contexts provided by individuals in the subnetwork 104. As will be described in greater detail below, the learned subnetwork 104 may be represented by a graph that comprises a plurality of nodes and a plurality of edges, wherein the plurality of nodes represent individuals in a social network of a user, and the plurality of edges represent a trusted relationship between individuals represented by the nodes of the graph.

The edges may be weighted to indicate an amount of trust between two individuals represented by two nodes in the graph, wherein such weight can alter depending on context, may be based upon which site or application was used to infer the relationship between individuals, etc. For example, a larger weight can indicate that a first individual in the social network of the user is an email contact of the user, is a contact in one or more social networking web sites of the user, is a telephone contact of the user, etc., while a lighter weight can indicate that the individual is only a contact in one social networking site. Furthermore, the learned subnetwork 104 may be a portion of an entire social network of a user, wherein such portion has knowledge or information that is useful for generating a recommendation for a particular context. That is, the learned subnetwork 104 may be specific to the particular context. As used herein, a context may be a topic, an item, an event, a circumstance, a combination of circumstances, etc. Thus, for instance, if a user wished to receive a recommendation for an Italian restaurant, the context associated with the learned subnetwork 104 may be “Italian restaurants”.

Furthermore, a context may be location or time dependent. For instance, if the user wished to receive a recommendation for art galleries in a particular city, then the context would be location-dependent with respect to the particular city. Generation of a learned subnetwork 104 is described in greater detail below. The ratings 106 of individuals in the learned subnetwork 104 may be any suitable ratings, including numerical ratings, a “thumbs up” or “thumbs down”, alphabetical ratings, etc. For example, if an individual likes a certain restaurant, such individual could give a “thumbs up” to that restaurant. In another example, if an individual enjoyed a particular movie, such individual may assign a certain number of stars to that movie. Again the data repository 102 can retain such ratings 106.

The system 100 further includes a receiver component 108 that receives the learned subnetwork 104 and the ratings 106 of individuals in the learned subnetwork 104 that are stored in the data repository 102. For instance, the receiver component 108 can receive such data by way of a network connection. In another example, the data repository 102 may be or be included in a hard drive of a computer that is accessible by the receiver component 108.

The system 100 further comprises a recommender component 110 that can output a recommendation to a user based at least in part upon the learned subnetwork 104 and the ratings of individuals in the learned subnetwork 104. The recommender component 110 can output the recommendation with respect to a context that corresponds to the learned subnetwork 104. The recommender component 110 can output the recommendation to any suitable computing device. For example, the recommender component 110 can configure the recommendation to be displayed on a display screen of a mobile computing device, such as a portable telephone or personal digital assistant.

In operation, a user may wish to receive a recommendation for a particular context. For instance, the user may wish to receive a recommendation for a steakhouse in a particular city. Responsive to the user providing such context, the receiver component 108 can receive a learned subnetwork that corresponds to the particular context. As indicated above, the learned subnetwork 104 may include individuals that have made ratings or have some knowledge that in some way pertains to the particular context. Thus, the learned subnetwork 104 includes fewer individuals than an entire social network of the user. For example, the learned subnetwork 104 may include individuals that have patronized and rated steakhouse restaurants in the area of interest. In another example, the learned subnetwork 104 may include individuals that have rated steakhouses in other areas. Furthermore, it can be learned that ratings for certain types of movies correspond to ratings of steakhouses (e.g., individuals that enjoy steakhouses also typically enjoy comedy films). Thus, the learned subnetwork 104 may include individuals that have provided ratings for contexts that pertain to the particular context of interest.

The recommender component 110 may then execute a recommendation algorithm over the learned subnetwork 104 to generate a recommendation to the user for the particular context (e.g., can output a restaurant that the recommender component 110 finds that the user is likely to enjoy). In another example, the recommender component 110 can output a list of all steakhouses in the particular area and can assign such steakhouses a rating that is indicative of how well the user is expected to like each of the restaurants.

The recommender component 110 can use any suitable recommendation algorithm in connection with generating the recommendation. For example, the recommender component 110 can employ an algorithm based at least in part upon: a personalized page rank system, a random walk system, a Min-cut system, local, global and iterative majority systems, a positive response axiom technique, among others. In another example, the recommender component 110 can employ a majority-of-majorities algorithm in connection with outputting a recommendation, based upon the learned subnetwork 104 and the ratings 106. Some examples of recommendation algorithms that can be used by the recommender component are described in United States Patent Publication No. 2009/0112989 filed on Apr. 28, 2008 and entitled, “TRUST-BASED RECOMMENDATION SYSTEMS,” the entirety of which is incorporated herein by reference.

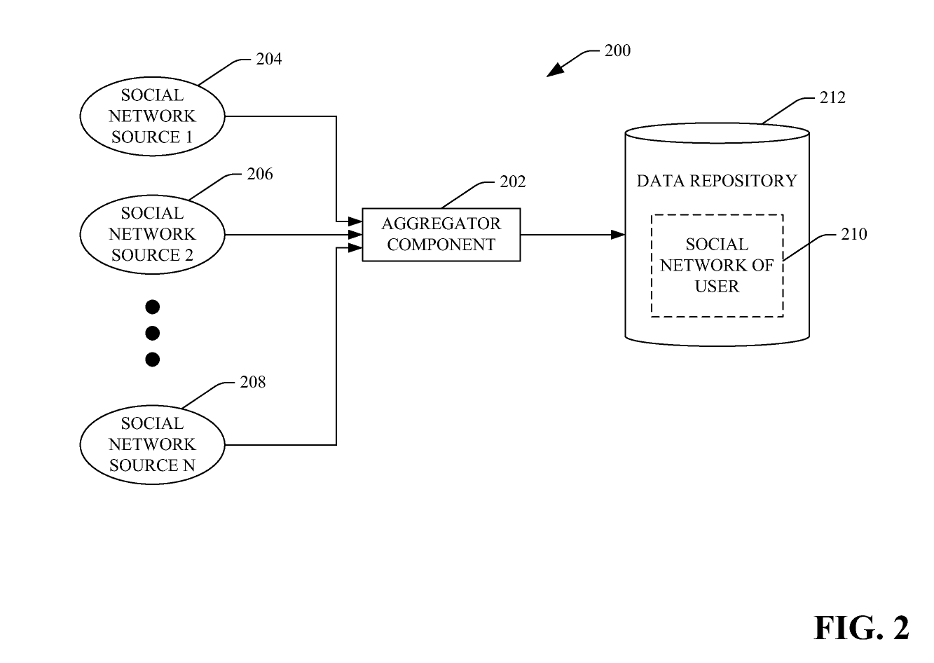

Referring now to FIG. 2, an example system 200 that facilitates generating and storing a data set that is representative of a social network of a user in a computer readable medium is illustrated. The system 200 includes an aggregator component 202 that can receive social network data from a plurality of social network sources 204-208. For instance, the social network source 204 may be a social networking web site that comprises a plurality of contacts (“friends”) of a user. The social network source 206 may be an email application that comprises a plurality of email contacts of the user. The social network source 208, for instance, may be telephone contacts of the user. Therefore, each of the social network sources 204-208 can provide the aggregator component 202 with information pertaining to the social network of the user. Other types of sources, including instant messaging contacts, contacts located on blogs, etc., are also contemplated.

The aggregator component 202 can receive social networking data from the social network sources 204-208, and can aggregate such data to generate a first data set that is representative of a social network of the user 210. Specifically, the aggregator component 202 can cause the social network of the user 210 to be stored in a data repository 212 of a computing device.

Pursuant to an example, the aggregator component 202 can receive data from the social network sources 204-208 and output an aggregated data set that is representative of the social network of the user 210. This aggregated data set may be represented by a graph that includes a plurality of nodes and a plurality of edges, wherein nodes of the graph are representative of individuals in the social network of the user, and edges in the graph are representative of trusted relationships between individuals in the social network of the user. In an example, weight of edges in the graph can be indicative of one or more of the following: which social network source or sources correspond to the edge, implicitly inferred level of trust between individuals connected by an edge, explicitly provided information pertaining to a trusted relationship between individuals in the social network of the user 210, etc. Furthermore, the graph that is representative of the social network of the user 210 may be directional in nature. For example, an edge between nodes in a single direction can indicate that the trusted relationship is unidirectional (e.g., a first user is a trusted contact of a second user, but the second user is not a trusted contact of the first user). Furthermore, the aggregator component 202 can update the social network of the user 210 as contacts are added or removed from one or more of the social network sources 204-208 and/or as additional social network sources are added.

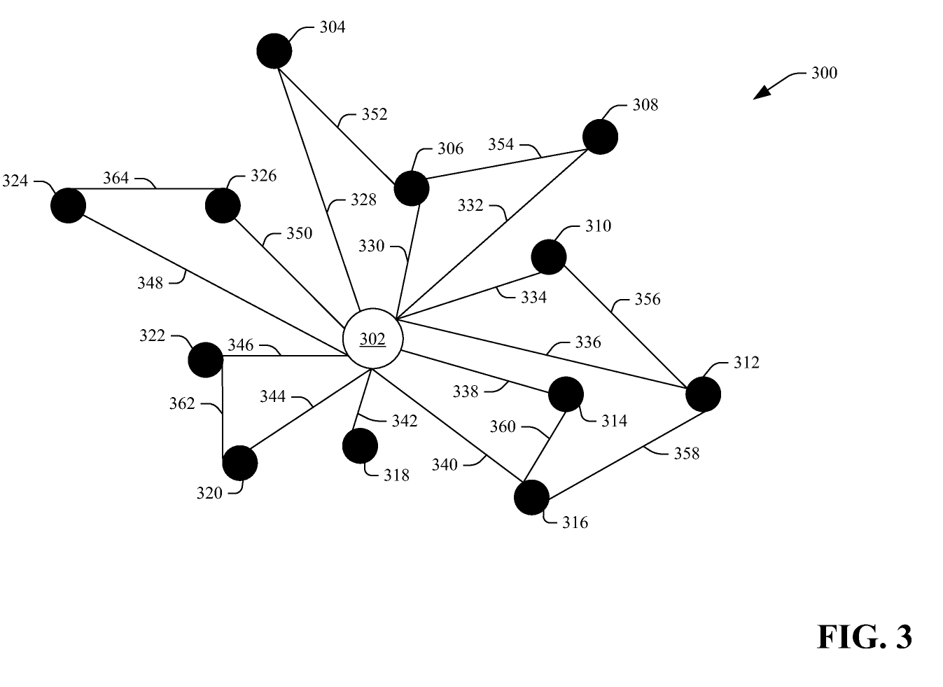

Now turning to FIG. 3, an example graph 300 that is representative of a social network of a user is illustrated. The graph 300 includes a first node 302 that is representative of a user of interest. The user of interest may have several trusted contacts in a social network. These contacts can be represented in the graph 300 by a plurality of nodes 304-326. Therefore, the user represented by the node 302 has some form of trusted relationship with each of the individuals represented by the nodes 304-326. The node 302 that represents the user of interest can be coupled to the plurality of nodes 304-326 by a corresponding plurality of edges 328-350. As noted above, while not shown in the graph 300, the edges 328-350 may be directional. For example, if the edge 328 was directed from the node 302 to the node 304, such direction can indicate that the person by the node 304 is a trusted contact of the user of interest represented by the node 302, but that the user of interest is not a trusted contact of the individual represented by the node 304. Furthermore, the edges 328-350 may be weighted, wherein the weight can be indicative of a level or amount of trust between the user of interest represented by the node 302 and the individuals in the social network of the user of interest, represented by the nodes 304-326. In an example, weights of the edges 328-350 may be context-dependent. For example, the user of interest may have a high amount of trust with respect to the individual represented by the node 306 for a first context (e.g., movie selections) but may have a relatively low level of trust for the same individual with respect to choosing a place to eat.

It can also be noted that the graph 300 comprises edges 352-364 between nodes 304-326. Such edges can represent trusted relationships between contacts of the user of interest represented by the node 302. For instance, the edge 356 can represent a trusted relationship between an individual represented by the node 310 and an individual represented by the node 312. Therefore, the social network of the user may include trusted relationships among contacts of the user.

Furthermore, while the graph 300 illustrates trusted relationships on a first degree basis between the user of interest represented by the node 302 and individuals in a social network of the user represented by nodes 304-326, it is to be understood that the graph 300 can be expanded to include contacts of contacts of the user of interest. The graph 300 may also include edges that represent relationships between such contacts. Pursuant to an example, an extent of the social network (e.g., one degree, two degrees, . . . ) can be selected by a user. As will be described in greater detail below, a social network of a user such as the social network represented by the graph 300 can be automatically modified to create a subnetwork that can be leveraged in connection with generating a recommendation for a particular context.

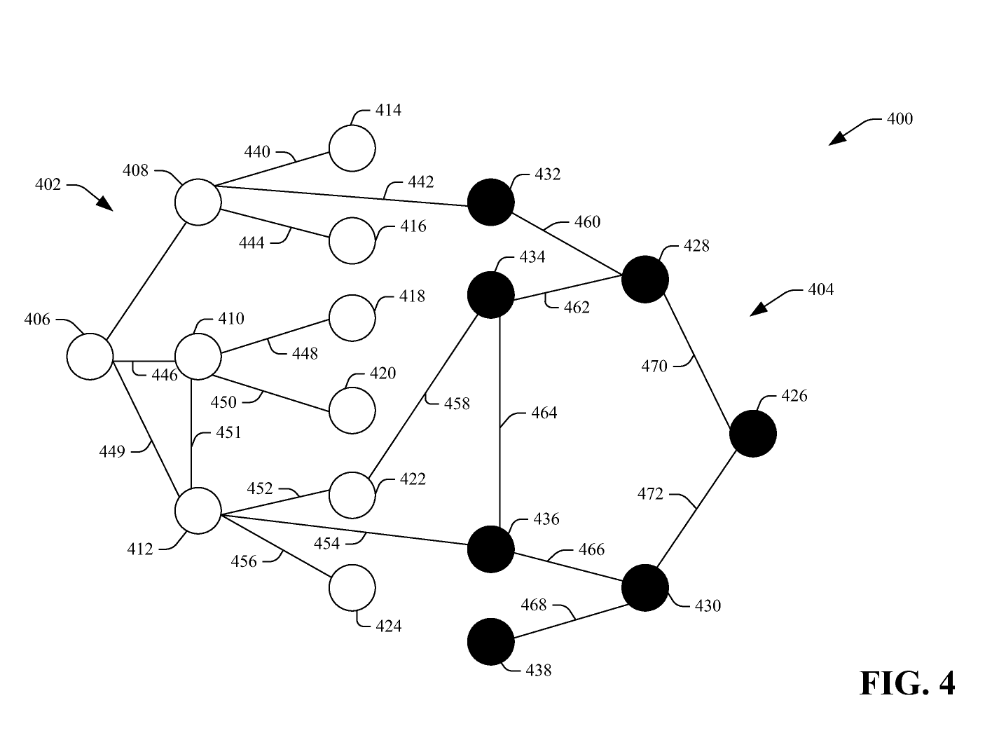

Referring now to FIG. 4, an example graph 400 that represents relationships between various contexts is illustrated. As can be discerned, the graph 400 comprises two hierarchies of contexts 402 and 404. The first hierarchy of contexts is represented by a plurality of clear nodes 402-424, while the second hierarchy of contexts is represented by a plurality of shaded nodes 426-438. For instance, the first hierarchy of contexts can represent a hierarchy of restaurants, and the second hierarchy of contexts can represent a hierarchy of movies. For instance, the node 406 can represent restaurants in general, while the nodes 408, 410 and 412 represent different types of restaurants. In an example, the node 408 can represent steakhouses, the node 410 can represent Italian restaurants, and the node 412 can represent pizzerias. The nodes 414-424 may then represent particular restaurants. Thus the nodes 414 and 416 represent particular steakhouses, the nodes 418 and 420 represent particular Italian restaurants, and the nodes 422 and 424 can represent particular pizzerias. Similarly, the node 426 can represent movies in general. The nodes 428 and 430 may represent types of movies, and the nodes 432-438 may represent particular movies. In an example, the node 428 can represent comedy films and the node 430 can represent dramatic films. Thus, the nodes 432 and 434 represent particular comedies, and the nodes 436 and 438 represent particular dramas. Edges 440-472 in the graph 400 can represent known or learned relationships between contexts represented by the nodes 406-438 in the graph 400.

For instance, a plurality of individuals may have assigned a plurality of ratings to one or more of the contexts represented in the graph 400. By analyzing such ratings and contexts (e.g., through use of a statistical model, machine learning/data mining techniques, and/or clustering), relationships between different contexts can be inferred. As shown in the graph 400, a relationship exists between the node 410 and the node 412, as evidenced by an edge 451. Continuing with the example provided above, then, the edge 451 represents a relationship between Italian restaurants and pizzerias. That is, if an individual highly rates Italian restaurants, that individual will also be likely to highly rate pizzerias. In another example, ratings provided to contacts by one or more users can indicate that if an individual provides a certain rating to a comedy film represented by the node 434, then such person is also likely to provide a particular rating to a certain pizzeria represented by the node 422. In other words, some relationship exists between the context represented by the node 434 and the context represented by the node 422.

The edges 440-472 may be weighted and/or directional. For example, a weight of an edge between contexts may represent a level of relation between such contexts. Thus, if the edge 451 is assigned a relatively high weight, then such weight indicates that a relatively strong relationship exists between the context represented by the nodes 410 and 412. A direction of an edge can indicate a direction of a relation between contexts. For instance, if the edge 464 is directed from the node 436 to the node 434, such direction can indicate that if an individual assigns a particular rating to a context represented by the node 436, that individual is likely to provide a particular rating to a context represented by the node 434. The inverse, however, may not be true.

In an example, relationships such as relationships represented by the graph 400 can be based upon a global population or upon a social network of a particular user. For instance, if the social network of the particular user has a sufficient amount of data corresponding therewith for a variety of contexts, relationships between contexts can be learned/inferred with respect to individuals in the social network. If additional data is desired to be obtained, then ratings outside of the social network of the user with respect to a variety of contexts can be used in connection with learning/inferring relationships between contexts. As will be described below, the learned relationships between contexts can be used in connection with generating a subnetwork of a social network of a user to employ with respect to generating a recommendation for the user.

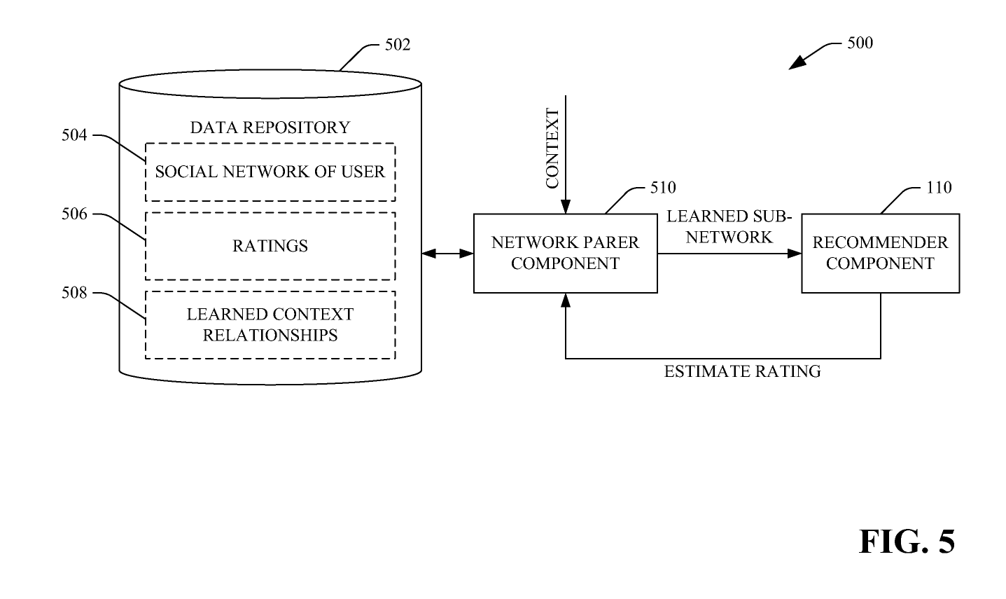

With reference now to FIG. 5, an example system 500 that facilitates automatically paring a social network of a user to generate a learned subnetwork of the social network of the user for a particular context is illustrated. The system 500 includes a data repository 502 that retains a social network of a user 504. The social network of the user 504 may be stored in the data repository 502 in any suitable format. For instance, the social network of the user 504 may be stored as a relational database. Furthermore, as indicated above, the social network of the user 504 may be represented by a first graph that comprises a plurality of nodes in a plurality of edges, such as the graph 300 depicted in FIG. 3. The data repository 502 may further comprise ratings 506 provided by individuals in the social network of the user with respect to a plurality of different contexts. As noted above, the ratings 506 may be in any suitable format, including a numerical rating, a “thumbs up” or “thumbs down” rating, an alphabetical rating, etc. The data repository 502 may also comprise learned context relationships 508. As described above, context relationships can be learned based at least in part upon ratings provided by a variety of users with respect to a plurality of different contexts. Furthermore, as noted above, relationships between contexts may be weighted, and such weights can be retained in the learned context relationships 508.

The system 500 additionally includes a network parer component 510. The network parer component 510 can automatically pare the social network of the user 504 to generate a subnetwork of the social network of the user 504 based at least in part on the ratings 506 and the learned context relationships 508, wherein the network parer component 510 generates the learned subnetwork according to a particular context. As noted above, the social network of the user 504 may be embodied as a first data set stored in the data repository 502, wherein a graph can be representative of the social network of the user 504. A network parer component 510 can receive a particular context and can act to automatically modify the graph to generate a second graph which is representative of a subnetwork of the social network of the user 504. The network parer component 510 can cause the learned subnetwork to be stored in a computer readable medium and/or provided to the recommender component 110 (FIG. 1).

The network parer component 510 can perform the automatic paring of the social network of the user 504 through utilization of any suitable mechanism. In a particular example, the network parer component 510 can employ a leave-one-out technique in connection with paring the social network of the user 504. For instance, an individual in the social network of the user may have generated a rating for a particular context such that the rating for such context for the individual is known. The network parer component 510 can ignore this known rating and can cause the recommender component 110 (FIG. 1) to output an estimate of such rating for the individual. For instance, the recommender component 110 can first output the recommendation or rating for the particular context by executing a suitable recommendation algorithm over an entirety of the social network of the user 504 (e.g., over the entirety of the graph that is representative of the social network of the user 504).

This determined/estimated rating can be compared with the actual rating provided by the individual to ascertain how effectively the social network of the user 504 can be used to output a rating. Thereafter, the network parer component 510 can remove an edge in the graph representative of the social network of the user 504, thereby creating a subnetwork of the social network of the user. The recommender component 110 may again be used to generate an estimated rating for the particular context for the user based at least in part upon such subnetwork. Again, this rating can be retained and compared with the known rating for the context provided by the user.

The network parer component 510 can iteratively remove edges from the graph representative of the social network of the user 504 until an error function is minimized, wherein the error function can be any suitable error function including, but not limited to, a mean squared error function, a weighted average of squared errors function, or other suitable error function. By utilizing this leave-one-out technique, a substantially optimized subnetwork of the social network of the user 504 can be ascertained for the user for the particular context.

Additionally or alternatively, to avoid overfitting, a cost function can be employed in connection with removing an edge of the social network of the user 504. For example, a cost can be assigned to each edge, wherein removing such edge causes the cost to be incurred. Accordingly, removal of an edge can be justified if a predictive error output by the error function is sufficiently low to offset the penalty of removing an edge from the graph that represents the social network of the user 504. Again, once the appropriate subnetwork of the social network of the user 504 is determined for a particular context, the network parer component 510 can cause such subnetwork for the particular context to be stored in a data repository 502 or another depository, and/or passed to the recommender component 110 to generate a recommendation to the user for the particular contest.

While the network parer component 510 has been described as employing a leave-one-out technique in connection with determining a subnetwork of the social network of the user 504 for a particular context, it is to be understood that any suitable machine learning and/or data mining technique may be employed. For example, the network parer component 510 may use classifiers, a k-nearest neighbor technique, support vector machines, Bayesian belief algorithms, artificial neural networks, classifiers, or the like in connection with ascertaining a subnetwork of the social network of the user 504 for a particular context.

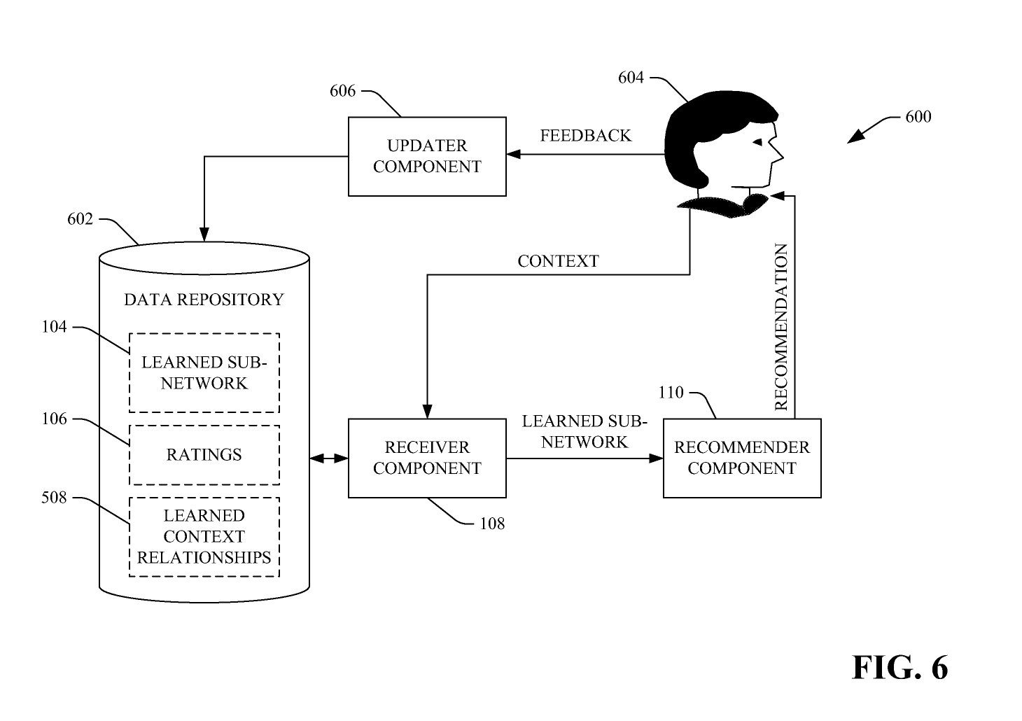

Turning now to FIG. 6, an example system 600 that facilitates automatically updating a learned subnetwork for a particular context is illustrated. The system 600 comprises a data repository 602, wherein the data repository 602 can include the learned subnetwork 104 (e.g., learned for a particular context), ratings 106 of individuals in the learned subnetwork 104, and the learned context relationships 508. The receiver component 108 can receive a particular context from a user 604. For instance, the context may be a predefined context that can be selected from a list in a graphical user interface. In an example, the user 604 can cause a graphical user interface to be displayed on a display screen of a computing device, wherein the graphical user interface comprises a plurality of menus, pulldown bars, sliders, etc. If the user wishes to receive a recommendation for a restaurant, the user 604 can select such context in the graphical user interface (e.g., “Provide me with a restaurant recommendation.”). Based at least in part upon the received context, the receiver component 108 can access the data repository 602 and retrieve the learned subnetwork 104 for such context. Additionally or alternatively, while not shown, the network parer component 510 can receive the context and generate the learned subnetwork 104 for the particular context “on the fly” based at least in part upon an entirety of a social network of the user 604, the learned context relationships 508, and ratings for various contexts provided by individuals in the social network of the user.

The recommender component 110 can be in communication with the receiver component 108 and can receive the learned subnetwork 104 from the receiver component 108. As noted above, the recommender component 110 may then generate a suitable recommendation algorithm over the learned subnetwork 104 and output a recommendation to the user 604 based at least in part upon the learned subnetwork for the particular context. The recommender component 110 may also generate the recommendation based at least in part upon the ratings 106.

After receiving and reviewing the recommendation and acting on such recommendation, the user 604 may agree or disagree with such recommendation. Accordingly, the user 604 may provide feedback pertaining to the recommendation generated by the recommender component 110. This feedback may be that the recommendation was accurate, that the user 604 liked or disliked a recommended item, or other suitable feedback. An update component 606 can receive the feedback and can automatically cause such feedback to be stored in a data repository 602 as ratings. Additionally, since the user 604 provides additional information pertaining to the context, the updater component 606 can automatically update the learned context relationships 508 retained in the data repository 602. Still further, since the user 604 generates additional information, the updater component 606 can automatically update the learned subnetwork 104 for the particular context, as well as update subnetworks for other contexts (e.g., due to relationships between contexts). While not shown, if the user 604 does not provide feedback, it may be inferred that the user 604 acted and agreed with the recommendation. Accordingly, the updater component 606 can update at least one of the learned subnetwork, the ratings, and/or the learned context relationships 508, based at least in part on the recommendation output by the recommender component 110.

From the above it can be ascertained that the user 604 can leverage her social network to obtain meaningful recommendations for contexts of interest to the user 604. Furthermore, such recommendations can be based upon a subset of individuals in the social network of the user 604 that have knowledge that is relevant to the context of interest to the user 604. That is, the user 604 can leverage knowledge of a portion of the social network of the user that has provided ratings that in some way pertain to the context that is of interest to the user 604.

In another example, the systems described herein may be in some way monetized. For instance, if the recommendation is for a particular product or service and the user 604 acts upon the recommendation, she may receive a discount on the product or service. In another example, one or more of the systems may be used in an advertising context, wherein advertisers may be willing to provide payment for advertisements that are based on a recommendation provided to the user 604. In still yet another example, some form of micropayment may be provided to users that rate products, services, or other contexts, such as to provide the systems described herein with additional information to further refine the generation of recommendations based upon subnetworks of a social network of a user.

Furthermore, while the paring of networks was described above as removing one or more edges or one or more nodes from a graph that is representative of a social network or subnetwork, it is to be understood that the network parer component 510 is in actuality modifying a data set that can be represented by such graph. For purposes of explanation, however, the actions of the network parer component 510 are described herein and in the claims as occurring on a graph.

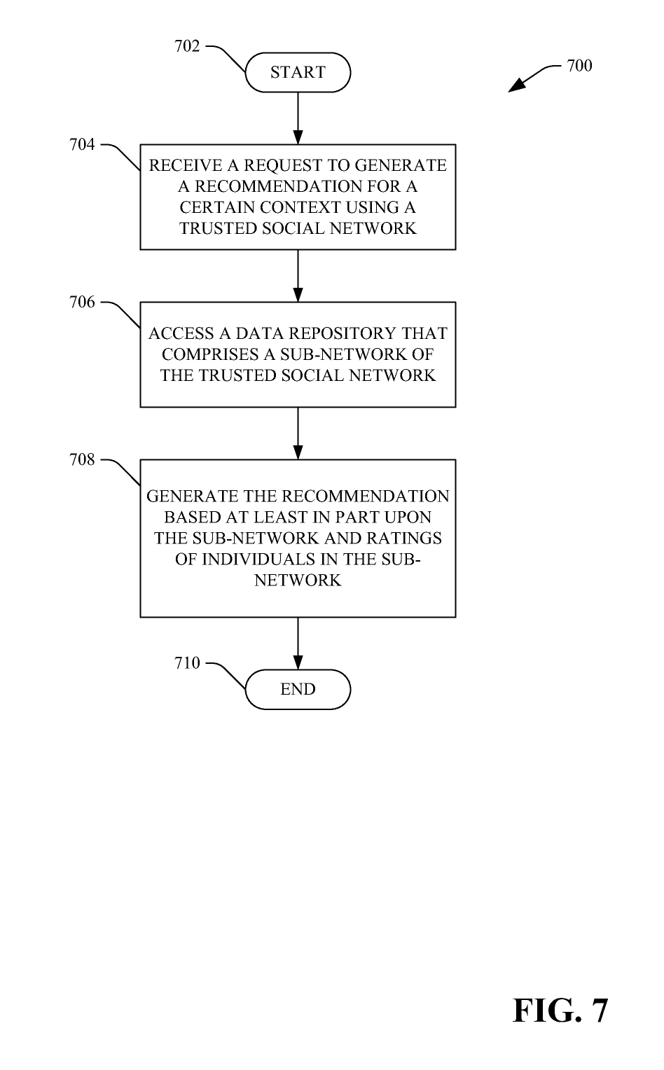

With reference now to FIGS. 7-9, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring now to FIG. 7, a methodology 700 that facilitates generating a recommendation based at least in part upon a subnetwork of a social network is illustrated. The methodology 700 starts at 702, and at 704 a request to generate a recommendation for a particular context using a trusted (social) network is illustrated. For example, the request can be from a particular user that wishes to leverage knowledge of people in her trusted social network in connection with generating a recommendation for a particular context (item, product, service, etc.).

At 706, a data repository is accessed, wherein the data repository comprises a subnetwork of the trusted social network. That is, the data repository comprises a data set that is representative of the subnetwork of the trusted social network. For example, the subnetwork of the trusted social network may comprise individuals that have provided ratings with respect to the particular context or contexts that are known or inferred to be related to the particular context. Thus, the individuals in the subnetwork have experience that is at least related to the context of interest to the user.

At 708, the recommendation for the certain context is generated based at least in part on the subnetwork of the trusted social network and ratings of individuals in the subnetwork of the trusted social network. For example, the ratings may be ratings for items, experiences, services, products, etc. that in some way pertain to the context of interest to the user. The methodology 700 completes at 710.

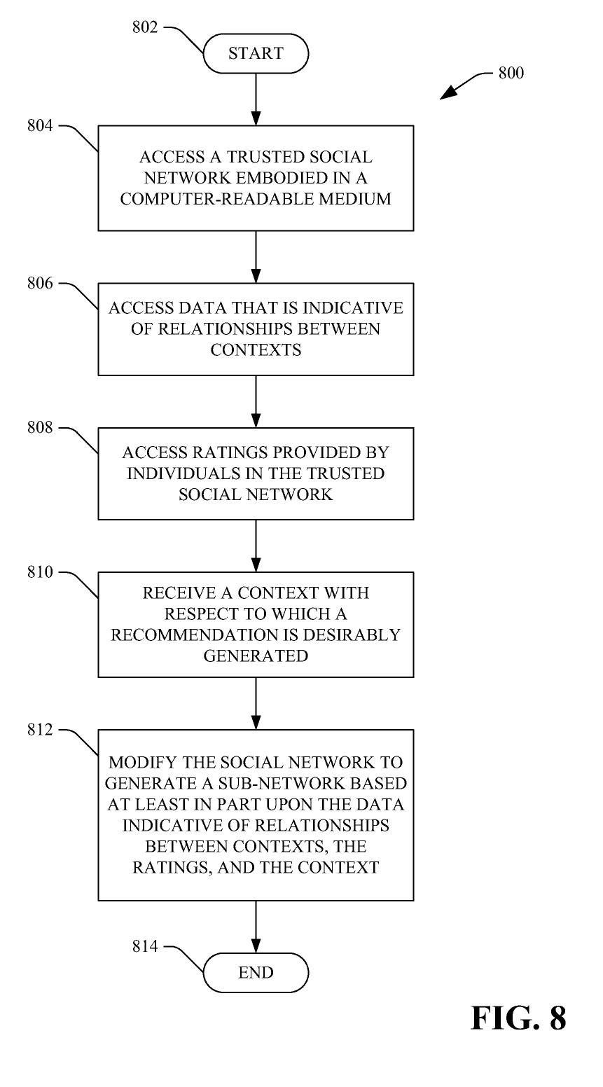

Turning now to FIG. 8, an example methodology 800 that facilitates automatically modifying a social network of a user to generate a subnetwork of the social network to be used in connection with outputting a recommendation for a particular context is illustrated. The methodology 800 starts at 802, and at 804 a trusted social network embodied in a computer-readable medium is accessed. As explained above, a graph can be used to represent the trusted social network, wherein nodes of the graph represent individuals in the social network, and edges represent trusted relationships between the individuals. In an example, the nodes in the graph may represent individuals in at least one of an email contact list of the user, a social networking website contact list of the user, a telephone contact list of the user, an instant messaging contact list of the user, or other suitable contact list.

At 806, data that is indicative of relationships between various contexts is accessed. This data can be learned based at least in part on ratings provided by individuals to various contexts, can be obtained by way of clustering, may be explicitly entered, etc.

At 808, ratings provided by individuals in the trusted social network are accessed. For example, the ratings may be stored in a data repository of a computing device.

At 810, a context with respect to which a recommendation is desirably generated is received. For example, the user may indicate that she wishes to receive a recommendation for a restaurant in a particular geographic region. In another example, the user may wish to receive a recommendation for a particular movie.

At 812, the social network is automatically modified to generate a subnetwork, wherein the modification is based at least in part upon the data indicative of relationships between contexts, the ratings accessed at 808, and the contexts received at 810. In an example, a supervised learning technique may be used in connection with removing at least one edge or at least one node from a graph that is representative of the trusted social network accessed at 804. The methodology 800 completes at 814.

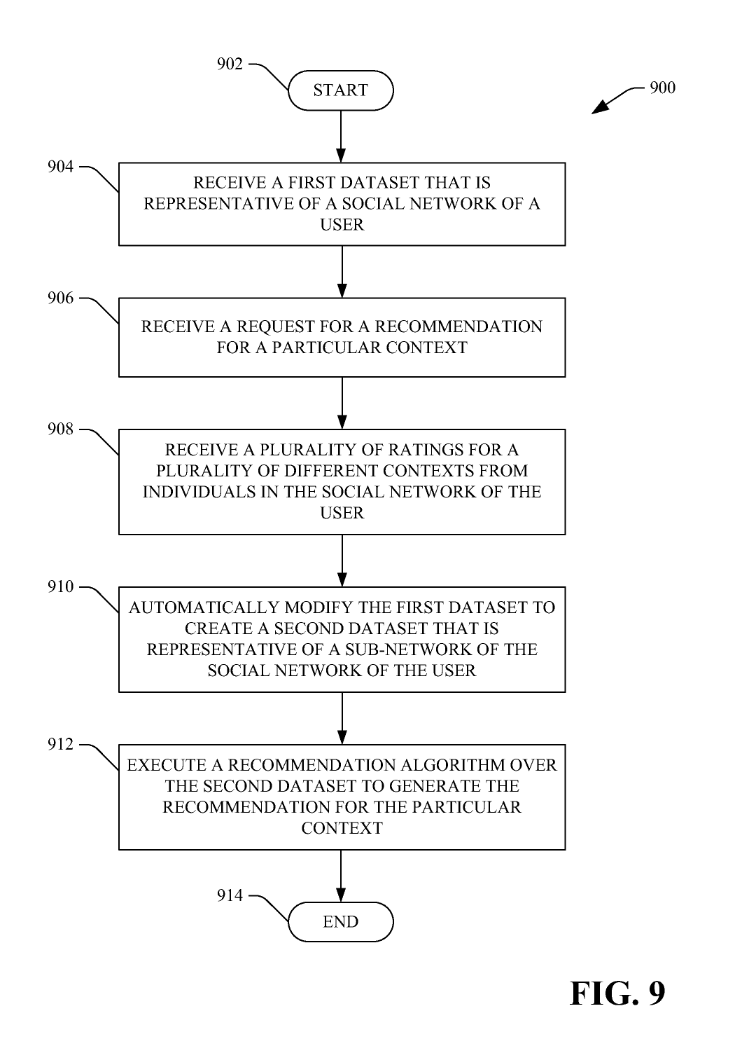

Referring now to FIG. 9, a methodology 900 that facilitates generating a recommendation to a user through utilization of a subnetwork of a social network of the user is illustrated. The methodology 900 starts at 902, and at 904 a first data set that is representative of a social network of a user is received. For example, the first data set may be representative of a first weighted graph that comprises nodes and weighted directional edges to indicate trusted relationships between nodes. Therefore, the first weighted graph can be representative of the social network of the user, wherein the nodes of the first weighted graph represent individuals in the social network of the user, and the weighted directional edges represent trusted relationships between individuals in the social network. Furthermore, the first data set can include data from multiple social network sources, including email, social networking web sites, etc.

At 906, a request is received for a recommendation with respect to a particular context. At 908, a plurality of ratings for a plurality of different contexts generated by individuals in the social network of the user are received.

At 910, the first data set is automatically modified to create a second data set that is representative of a subnetwork of the social network of the user. For instance, individuals in the subnetwork of the social network of the user may have provided ratings that somehow pertain to the context pertaining to the request for the recommendation received at 906. Specifically, the second data set can be representative of a second weighted graph, and the second weighted graph can be representative of the subnetwork of the social network. Specifically, the first data set can be modified by removing at least one edge of the first weighted graph to generate the second weighted graph. The first data set can be automatically modified, based at least in part upon the received plurality of ratings and the particular context.

At 912, a recommendation algorithm is executed over the second data set to generate the recommendation for the particular context. Thus the recommendation is based upon ratings from individuals that have some association with the context. The methodology 900 completes at 914.

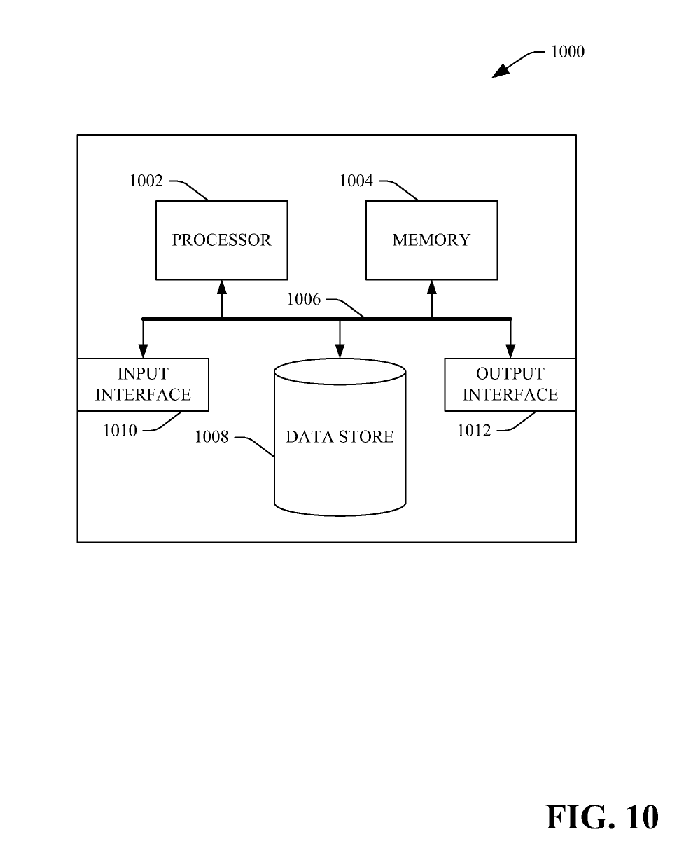

Now referring to FIG. 10, a high-level illustration of an example computing device 1000 that can be used in accordance with the systems and methodologies disclosed herein is illustrated. For instance, the computing device 1000 may be used in a system that supports automatic generation of recommendations for particular contexts. In another example, at least a portion of the computing device 1000 may be used in a system that supports automatically modifying a data set that represents a trusted social network of a user, to generate a subnetwork of such trusted social networks for a particular context. The computing device 1000 includes at least one processor 1002 that executes instructions that are stored in a memory 1004. The instructions may be, for instance, instructions for implementing functionality described as being carried out by one or more components discussed above or instructions for implementing one or more of the methods described above. The processor 1002 may access the memory 1004 by way of a system bus 1006. In addition to storing executable instructions, the memory 1004 may also store ratings provided by users, relationships between contexts, a trusted social network, etc.

The computing device 1000 additionally includes a data store 1008 that is accessible by the processor 1002 by way of the system bus 1006. The data store 1008 may include executable instructions, ratings provided by individuals, a trusted social network of a user, a subnetwork of the trusted social network for a particular context, one or more recommendation algorithms, etc. The computing device 1000 also includes an input interface 1010 that allows external devices to communicate with the computing device 1000. For instance, the input interface 1010 may be used to receive instructions from an external computer device, from a user, etc. The computing device 1000 also includes an output interface 1012 that interfaces the computing device 1000 with one or more external devices. For example, the computing device 1000 may display text, images, etc. by way of the output interface 1012.

Additionally, while illustrated as a single system, it is to be understood that the computing device 1000 may be a distributed system. Thus, for instance, several devices may be in communication by way of a network connection and may collectively perform tasks described as being performed by the computing device 1000.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method comprising the following computer-executable acts:
receiving a request to generate a recommendation for a user for a particular context;
a) accessing a data repository in a computing device that comprises:
i) a first data set that is representative of a first graph that includes a plurality of nodes and a plurality of edges that connect such nodes, wherein the graph is representative of a social network of the user, wherein the nodes in the graph are representative of individuals in the social network of the user and edges in the graph represent trusted relationships between individuals represented by nodes;
ii) ratings provided by one or more of the individuals in the social network with respect to a plurality of contexts;
b) automatically removing at least one node and at least one edge from the graph to create a second data set based at least in part upon the particular context and the ratings, wherein the second data set is representative of a second graph, wherein the second graph is representative of a subnetwork of the social network; and
c) automatically generating the recommendation for the user for the particular context based at least in part upon the subnetwork of the social network and rankings for various contexts generated by individuals in the subnetwork of the social network.

2. The method of claim 1, wherein nodes in the first graph are representative of individuals in at least one of:
an email contact list of the user;
a social networking website contact list of the user;
a telephone contact list of the user; or
an instant messaging contact list of the user.

3. The method of claim 1, wherein the particular context is a pre-defined context selected from a graphical user interface by the user.

4. The method of claim 1, wherein edges of the first graph are weighted to indicate a level of trust between the user and individuals in the social network of the user.

5. The method of claim 4, further comprising:
receiving feedback from the user with respect to the recommendation; and
automatically modifying a weight of at least one edge in the first graph based at least in part upon the feedback of the user.

6. The method of claim 1, wherein automatically removing the at least one node and the at least one edge from the graph to create the second data set comprises utilizing a supervised learning technique to determine which nodes and which edges to remove from the first graph.

7. The method of claim 1, wherein automatically removing the at least one node and the at least one edge from the graph to create the second data set comprises:
receiving a learned relationship between contexts; and
automatically removing the at least one node and the at least one edge from the graph based at least in part upon the learned relationship between contexts.

8. The method of claim 1, wherein automatically removing the at least one node and the at least one edge from the graph to create the second data set comprises using a leave one out estimation approach in connection with determining which nodes and which edges to remove from the first graph.

9. The method of claim 8, wherein automatically removing the at least one node and the at least one edge from the graph to create the second data set comprises:
assigning a penalty value for removing an edge from the first graph;
determining an error value when removing the edge from the first graph; and
removing the edge from the first graph based at least in part upon a combination of the error value and the penalty value with respect to the edge.

10. The method of claim 1, further comprising monetizing the recommendation.

11. The method of claim 10, wherein the output recommendation is in the form of an advertisement.

12. The method of claim 1, wherein the social network comprises contacts that are at least one degree of separation from the user.

13. The method of claim 1, wherein the first graph is representative of an aggregation of data from multiple social network sources pertaining to the user.

14. A system comprising the following computer-executable components:
a network parer component that receives:
a first data set that is representative of a first graph, wherein the first graph is representative of a social network of a user, wherein the first graph comprises nodes that are representative of individuals in the social network of the user and edges that represent trusted relationships between individuals in the first graph;
ratings from a plurality of individuals in the social network of the user pertaining to various contexts; and
a request to generate a recommendation for the user for a particular context, wherein the network parer component automatically pares the first graph to remove at least one edge from the first graph to create a second graph that is representative of a subnetwork of the social network, wherein the network parer component automatically pares the first graph based at least in part upon the ratings from the plurality of individuals in the social network of the user and the particular context; and
a recommender component that generates the recommendation based at least in part upon the second graph.

15. The system of claim 14, wherein the network parer component receives learned relationships between contexts and automatically pares the first graph to remove at least one edge from the first graph based at least in part upon the learned relationships between contexts.

16. The system of claim 14, wherein the particular context is at least one of time-dependent or location-dependent.

17. The system of claim 14, further comprising an updater component that receives feedback from the user pertaining to the recommendation and automatically updates the subnetwork based at least in part upon the received feedback.

18. The system of claim 14, wherein edges of the first graph are weighted, and wherein weights of edges in the first graph are modified depending on a context of interest.

19. The system of claim 14, wherein weights of edges in the first graph are modified based upon feedback from the user pertaining to the generated recommendation.

20. A computer-readable medium comprising instructions that, when executed by a processor, cause the processor to perform the following acts:
receiving a first data set that is representative of a first weighted graph, wherein the first weighted graph comprises nodes and weighted, directional edges that indicate trusted relationships between the nodes, wherein the first weighted graph is representative of a social network of the user, wherein the nodes of the first weighted graph represent individuals in the social network of the user and the weighted, directional edges represent trusted relationships between individuals in the social network, and wherein the first data set comprises data from multiple social network sources;
receiving a request for a recommendation for a particular context;
receiving a plurality of ratings for a plurality of different contexts generated by individuals in the social network of the user;
automatically modifying the first data set to generate a second data set that is representative of a second weighted graph, wherein the second weighted graph is representative of subnetwork of the social network, wherein the first data set is modified by removing at least one edge of the first weighted graph to generate the second weighted graph, wherein the first data set is automatically modified based at least in part upon the received plurality of ratings and the particular context; and
executing a recommendation algorithm over the second data set to generate the recommendation for the particular context.
